(19) United States
(12) Patent Application Publication
(10) Pub. No.: US 2022/0388903 A1
(43) Pub. Date: Dec. 8, 2022

(54) Glass-To-Metal Seal

(71) Applicant: TE Connectivity Sensors Germany GmbH, Dortmund (DE)

(72) Inventors: Horst Sirtl, Dortmund (DE); Stefan Andreas Roessinger, Dortmund (DE)

(73) Assignee: TE Connectivity Sensors Germany GmbH, Dortmund (DE)

(21) Appl. No.: 17/835,494

(22) Filed: Jun. 8, 2022

(30) Foreign Application Priority Data
Jun. 8, 2021 (EP) 21178293.3

(51) Int. Cl. C03C 27/02

(52) U.S. Cl. CPC C03C 27/02

(57) ABSTRACT

An assembly includes a metal member containing a glass-forming component and a glass member bonded to the metal member in a glass-to-metal seal.

### CROSS-REFERENCE TO RELATED APPLICATIONS

This application claims the benefit of the filing date under 35 U.S.C. § 119(a)-(d) of European Patent Application No. 21178293.3, filed on Jun. 8, 2021.

### FIELD OF THE INVENTION

The invention relates to an assembly comprising a metal member and a glass member bonded to the metal member in a glass-to-metal seal.

### BACKGROUND

Glass-to-metal seals are known in the art. A glass-to-metal seal is formed by a metal member and a glass member which are bonded to each other, in particular, chemically bonded. Glass to-metal seals are used for different purposes. They are, just by way of example, used when a wire is led through a glass element, such as a light bulb, in order to connect an element in the interior of the glass element to the outside. Another example for a glass-to-metal seal is a glass member covering a metal member, e.g. a wire, which is covered partly by the glass member for protection. Furthermore, the glass member can be used to mechanically fixate the wire to an additional element.

If the bond between glass and metal is insufficient, the bond may suffer from mechanical or thermal stress and, in the worst case, break. Thermal stress for a glass-to-metal seal may be induced by temperature changes, in particular fast temperature changes or changes over a wide temperature range. Mechanical stress may be induced by vibrations, tensile forces or other.

### SUMMARY

An assembly includes a metal member containing a glass-forming component and a glass member bonded to the metal member in a glass-to-metal seal.

### BRIEF DESCRIPTION OF THE DRAWINGS

The invention will now be described by way of example with reference to the accompanying Figures, of which:

FIG. 1 is a schematic sectional depiction of an assembly according to an embodiment;

FIG. 2 is a schematic sectional depiction of an assembly according to an embodiment and an electrical device;

FIG. 3 is a schematic sectional depiction of a plurality of glass-forming components in a metal member according to an embodiment; and

FIG. 4 is a schematic sectional depiction of a plurality of glass-forming components in a metal member according to another embodiment.

### DETAILED DESCRIPTION OF THE EMBODIMENT(S)

In the following, the invention and its improvements are described in greater detail, using exemplary embodiments and with reference to the drawings. The various features shown in the embodiments may be used independently of each other in specific applications. In the following figures, elements having the same function and/or the same structure will be referenced by the same reference signs.

The improvements described with respect to the assemblies and their advantages also relate to the method according to the invention. Likewise, the improvements and the advantages mentioned with respect to the method also apply to the assemblies according to the invention. In other words, the method according to the invention is used for producing assemblies according to the invention.

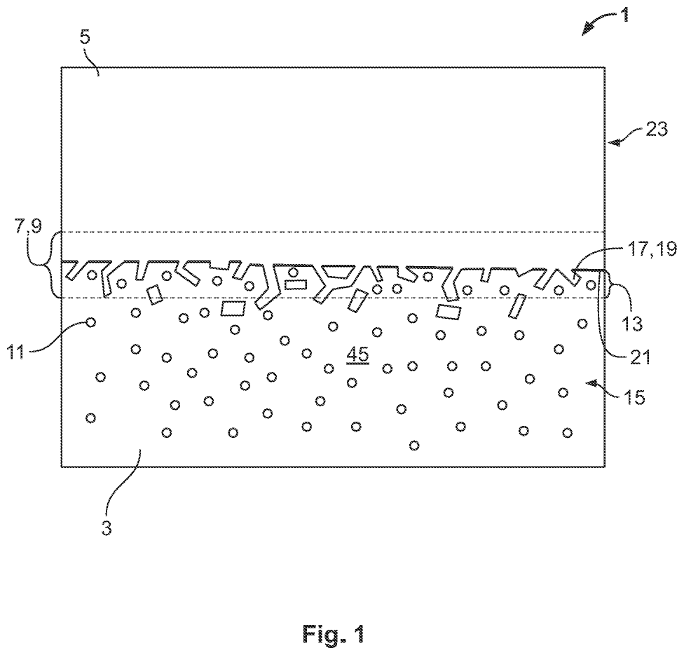

In the following, an embodiment of an assembly 1 is described with respect to FIG. 1. The figure is not true to scale and serves only for explanatory reasons.

The assembly 1 comprises a metal member 3 and a glass member 5. The glass member 5 is bonded to the metal member 3 in a glass-to-metal seal 7. The glass to metal seal 7 is depicted as an interface region 9 and indicated by the dashed line in FIG. 1.

The main constituent of the metal member 3 is a metal. The metal of the metal member 3 may be at least one of the following: nickel, silver, platinum, rhodium, iridium, palladium, aluminum, copper, gold, or an alloy containing any composition of the aforementioned materials. The main constituent of the glass member 5 is glass. By way of example, the glass member 5 may predominantly contain a silicate or a borosilicate.

The metal member 3 comprises glass-forming components 11. The glass-forming components 11 are indicated as circles in FIG. 1. The glass-forming components 11 may contain or consist of one of the following: silicon, germanium, phosphor, boron, arsenic, antimony. In addition to the glass forming components 11, also materials known as glass stabilizers may be added to the metal member 3, for example but not limited to calcium, strontium, barium, iron, manganese, zirconium and aluminum, if it is not the main material of the metal member 3.

The material of the glass member 5 and the glass-forming components 11 are chosen to fit to each other. Hence, a chemical bond between the glass member 5 and the glass-forming components 11 may, firstly, be easier to be achieved and may, secondly, form a particular stable bond between the glass member 5 and the metal member 3. If the glass member 5 predominantly contains a silicate, the glass-forming components 11 may contain silicon. Said silicon may get oxidized and form silicate which can easily bond to the silicate from the glass member 5.

A concentration of the glass-forming components 11 in the metal member 3 may be higher than 0.4%, or higher than 4%. In other words, the glass-forming components 11 are intentionally added to the material of the metal member 3 and are not only traces in the material of the metal member 3.

The aforementioned concentration of the glass-forming components 11 in the metal member 3 at least exists in near surface regions 13 of the metal member 3, in particular in the near-surface regions 13 of the metal member 3 that are part of the transition region 9, in which the metal member 3 and the glass member 5 are in contact with each other. Other regions do not necessarily need to be provided with a large amount of glass-forming components 11. In addition, other regions of the metal member 3 may also contain no glass-forming components.

By way of example, FIG. 1 shows the glass-forming components 11 as being evenly distributed in the metal member 3. However, this is not mandatory. In the alternative to evenly distributed glass-forming components 11, the concentration of the glass-forming components 11 may increase towards the transition region 9. In an embodiment, the concentration of the glass-forming components 11 may increase from an inner region 15 towards the transition region 9. The concentration may increase continuously towards the transition region 9. If the metal member 3 is bonded to the glass member 5 on several sides, the concentration may increase from a central region or core region 45 towards the transition region 9. This may, for example, be the case when the metal member 3 has a circular cross section and the glass member 5 is bonded to the metal member 3 on at least a section of its outer circumference. The circular cross section of the metal member 3 is not a limitation and used hereby only for explanatory reasons.

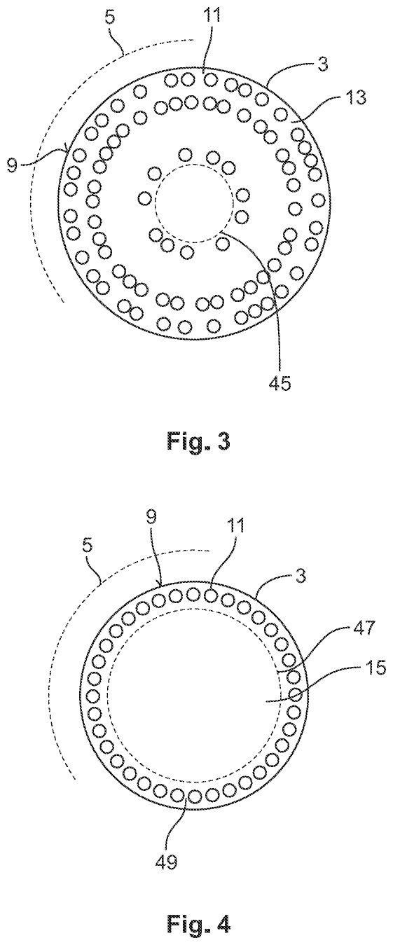

Alternative distributions of the glass-forming components 11 in the metal member 3 are described in further detail below with respect to FIGS. 3 and 4.

Due to the glass-forming components 11 in the metal member 3, the metal member 3 contains glass 17 which may be present in the form of glass networks or glass matrices 19 in the material of the metal member 3, at least in its near-surface regions 13. The glass matrices 19 are indicated as rectangular structures in FIG. 1. However, this is for illustration only. The glass matrices 19 may have any other shape and may also be interconnected with each other.

The glass may be formed when the glass-forming components 11 react chemically with each other and/or with other elements. The glass matrices 19 may be formed from oxidized glass-forming components 11 in the metal member 3. Hence, the majority of the glass matrices 19 are present in the near-surface regions 13, where the glass forming components 11 may have easier contact with oxides from the ambient atmosphere.

The glass matrices 19 which extend to the surface 21 of the metal member 3 are in direct contact with the glass member 5. Hence, these matrices 19 may form chemical bonds with the material of the glass member 5. Thereby, a continuous glass structure 23 shown in FIG. 1 is formed from the glass member 5 and the glass matrices 19. The continuous glass structure 23 extends into the metal member 3, at least into its near-surface regions 13. Thereby, a strong mechanical connection between the glass member 5 and the metal member 3 is achieved.

The strong bond between the glass member 5 and the metal member 3 may allow omitting the matching of the coefficients of thermal expansion (CTE) of the glass member 5 and the metal member 3. The CTE the glass member 5 may differ from the CTE of the metal member 3, for example by more than 10%. The bond between the glass member 5 and the metal member 3 is strong enough to keep the members 5 and 3 bonded even when temperature changes lead to different expansions of the members 5 and 3. Omitting the matching of the CTE eliminates the risk of contaminating the members 5 and 3 with elements that may reduce the function of the assembly and lead to failures.

Another benefit with regard to the coefficient of thermal expansion is that the at least one glass-forming component 11 in the metal member 3 may alter the response of the metal member 3 to temperature changes. If, for example, the metal member 3 is made from a ferromagnetic material, such as nickel, the material usually has an anomaly in the CTE around the Curie temperature (Curie point), at which the material loses its ferromagnetic properties. This anomaly leads to rapid changes in the expansion and may compromise the structural integrity of the bond between the metal member 3 and the glass member 5. However, the addition of the glass-forming component 11 may turn the material of the metal member 3 into a paramagnetic material even below the Curie point. Hence, the anomaly in CTE may be eliminated or at least reduced and does not constitute a risk to the structural integrity of the bond between the glass member 5 and the metal member 3.

The glass formed from oxidized glass-forming components 11 is typically electrically insulating. However, since an electrically conductive connection between the metal member 3 and the glass member 5 is not intended, this is not a drawback.

It is, just by way of example, known to use oxidized nickel for metal members that are to be covered with glass. However, nickel is not a glass-forming component as nickel oxide is not a glass. The oxidized nickel is sometimes used to improve the wettability of the metal member 3 before the glass member 5 is deposited there on. However, this is to be distinguished from the invention, in which glass-forming components 11 are used to form glass in the metal member 3 that is then chemically bonded to the glass member 5.

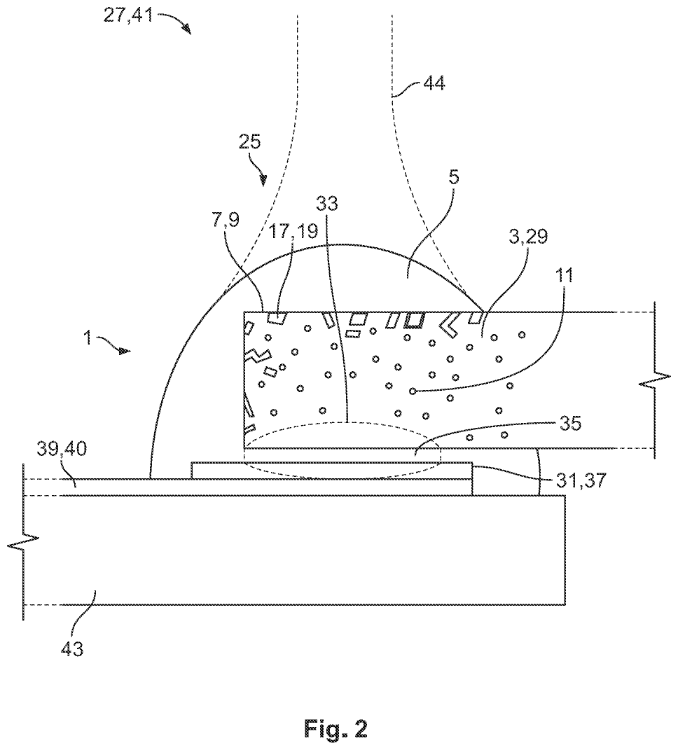

The glass member 5 may be formed by depositing glass melt 44 onto the metal member 3, as shown in FIG. 2. The molten glass may form chemical bonds with the glass 17 in the metal member 3 formed by the oxidized glass-forming components 11. This oxidizing process may happen before the deposition of the glass member 5. Alternatively, the process happens during or after depositing the glass melt 44, due to the temperature of the glass melt 44. When the metal member 3 is heated by the glass melt, oxygen may diffuse into the metal member 3, at least into its surface regions and oxidize the glass-forming components 11 therein. Due to the glass-forming components 11 in the metal member 3, the glass-to-metal seal 7 may be improved, at least with respect to the structural integrity.

Instead of or additional to using the heat of the glass melt, the metal member 3 may be thermally treated or, in other words, heated before or during the deposition of the glass melt 44. Thereby, the oxidation rate of the glass-forming components 11 in the metal member may be increased.

When the glass melt 44 cools down, or, in other words, anneals, a solid glass member 5 is formed. Just by way of example, the glass melt 44 may be heated up to a temperature around 800° C. and may be deposited with a temperature between 700 and 800° C. The temperatures needed for the application of the glass member 5 will vary by their glass compositions and should not limit the example.

In another embodiment, a mixture of glass and/or ceramic powders is applied with an organic binder agent to provide a dispensable paste, which is applied on the metal member 3, evenly covering the electrically conductive connection member 31 and being transformed with temperature treatment into a glass member 5 or glass ceramic or a glass composite, which is later representing the glass member 5.

In a further embodiment, a preform of the glass material can be joined with the metal member 3, evenly covering the electrically conductive connection member 31 and being transformed with temperature treatment into a glass member 5 or glass ceramic or a glass composite, which is representing later the glass member 5.

In all mentioned options next to the glass member 5 and metal member 3, also a third material type, e.g. ceramics, can be incorporated to this seal.

In the following, an application of an assembly 1 according to the invention, in particular an assembly 1 of the aforementioned type, is described with respect to FIG. 2. FIG. 2 shows an assembly 1 with a glass-to-metal seal 7 as part of a glass covered assembly 25, which itself is part of an electrical device 27. The electrical device 27 is described as a temperature sensor element 41, which can be used as part of a thermometer assembly, such as a resistance thermometer or a thermistor.

The metal member 3 may be a lead wire 29, as shown in FIG. 2. The lead wire 29 is electrically and mechanically connected to an electrically conductive connection member 31, at least at an interface region 33. In the interface region 33, the metal member 3 and the connection member 31 are connected via a mechanical and electrical connection 35. The mechanical and electrical connection 35 may be a material joint 35, in particular a solder joint, a weld joint or a wire bond joint. The material joint 35 is depicted as an intermediate layer between the metal member 3 and the connection member 31, for explanatory reasons only.

By way of example, the connection member 31 is a contact pad 37 that serves to electrically connect a temperature dependent resistive element 39 with the lead wire 29. The temperature dependent resistive element 39 may be part of a platinum measuring structure 40 of the temperature sensor element 41. The contact pad 37 is formed as at least one conductive layer arranged on the element 39 to provide a conductive connection between the measuring structure 40 and the lead wire 29 and the material joint 35. The resistive element 39 is directly or indirectly connected to the connection member 31 in an electrically conductive manner.

A common substrate 43 shown in FIG. 2 serves to carry and stabilize the element 39 and the contact pad 37. The substrate 43 may be made from a ceramic material, in particular aluminum oxide.

As mentioned before, the metal member 3 is connected to the contact pad 37. The contact pad 37 is electrically and mechanically connected to the element 39.

In order to increase the structural integrity of the electrical device 27 and to further fixate the lead wire 29 thereto, the glass member 5 is provided and bonded to the lead wire 3. The glass member 5 covers the metallic member 3, represented by the lead wire 29, in a region that also comprises the interface region 33. Thereby, the material joint 35 between the lead wire 3 and the contact pad 37 is protected. Furthermore, the glass member 5 also covers the contact pad 37 and thereby protects the contact pad 37.

The glass member 5 may be in contact with the element 39 and the substrate 43. The glass member 5 thereby serves to fixate the lead wire 29 to the remaining electrical device 27. Due to the bond between the glass member 5 and the lead wire 29, which represents the metal member 3, the lead wire 29 is mechanically fixated by the glass member 5. Hence, a pullout force that needs to be overcome to remove the lead wire 29 from the electrical device 27 is increased, improving structural integrity. In addition, the glass member 5 may protect the lead wire 29 from the environment.

The cross-sectional shape of the lead wire 29 providing the metal member 3, shown further in FIGS. 3 and 4, is not limited to circular geometries. It could be square, rectangular, polygonal or even irregular. Even the wire shape in longitudinal sections depicted in FIGS. 1 and 2 as rectangular are not limited to any basic geometry.

To form the glass member 5, glass melt 44 shown in FIG. 2 may be deposited on the metal member 3, and, in an embodiment, also on the contact pad 37, in an embodiment also on the element 39 and the substrate 43. When the melt 44 cools down, it forms the glass member 5. The glass melt 44 flowing on the metal member 3 is indicated by the dashed line in FIG. 2.

A method for building the glass member 5 is to apply a mixture of glass and/or ceramic powders with an organic binder agent to provide a dispensable paste, which is applied on the metal member 3, evenly covering the electrically conductive connection member 31 and being transformed with temperature treatment into a glass member 5, glass ceramic or a glass composite, which is later representing the glass member 5.

As mentioned above with respect to FIG. 1, the glass-forming component may be evenly distributed in the metal member 3. However, this is not mandatory. The glass forming components 11 may be present in certain regions in the metal member 3 only, in particular in the near-surface regions 13 thereof. The glass-forming components 11 are needed the most in those regions which are close to the glass member 5.

FIGS. 3 and 4 show cross sections of metal members 3 with different distributions of the glass-forming components 11 therein. For better visibility, the glass member 5 is only indicated by a dashed line in FIGS. 3 and 4. The circular cross section of the metal member 3 is not a limitation and used hereby only for explanatory reasons.

FIG. 3 shows the cross section of a metal member 3 with a distribution of glass-forming components 11 that increases from a core region 45 towards the transition region 9, in which the metal member 3 is in contact with the glass member 5. In the core region 45 of the metal member 3, a very small amount of or even no glass-forming components 11 may be present. Towards the transition region 9, however, the concentration of the glass-forming components 11 increases. In the surface-near region 13, the concentration of the glass-forming components 11 is sufficient to form a chemical bond with the glass member 5.

FIG. 4 depicts a metal member 3 with a step in the distribution of the glass-forming components 11. An inner region 17 is provided with no or a negligible amount of glass-forming components 11, i.e. less than 4%, or less than 0.4%. However, between the inner region 17 and the interface region 9, glass-forming components 11 are present in a concentration that is sufficient to form the chemical bond with the glass member 5, for example higher than 0.4% or higher than 4%. Such a distribution may, for example, be achieved by first providing a metal body 47 that contains no or a negligible amount of glass-forming components 11. This metal body 47 forms the inner region 17.

The metal body 47 may be provided with a sheath or shell 49 that contains the glass-forming components 11. Just by way of example, the metal body 47 can be inserted into the sheath 49. By providing the metal body 47 with the sheath 49, the metal member 3 is formed.

In the alternative, the metal body 47 may be provided with a coating that contains the glass-forming components 11, in particular a dispersive coating. Said coating may then be regarded as the sheath 49 shown in FIG. 4. The glass-forming components 11 may be present as particles or inside capsules in said coating. During the deposition of the glass member 5, the dispersive coating or at least the glass-forming components 11 therein may melt and get distributed on and/or in the metal member 3. An additional thermal treatment may also be part of the method, in order to allow the glass-forming components 11 from a coating to evenly distribute on the metal member 3 or to diffuse into the metal member 3, at least into its near-surface regions 13.

What is claimed is:

1. An assembly, comprising:
a metal member containing a glass-forming component; and
a glass member bonded to the metal member in a glass-to-metal seal.

2. The assembly of claim 1, wherein the glass-forming component contains at least one of: silicon, germanium, phosphor, boron, arsenic, and antimony.

3. The assembly of claim 1, wherein a concentration of the glass-forming component is greater than 0.4% in a region of the metal member.

4. The assembly of claim 1, wherein a concentration of the glass-forming component in the metal member increases toward a transition region between the metal member and the glass member.

5. The assembly of claim 1, wherein a major constituent of the metal member is at least one of: nickel, silver, platinum, aluminum, iridium, palladium, rhodium, gold, and copper.

6. The assembly of claim 1, wherein the metal member is a wire.

7. The assembly of claim 1, wherein a coefficient of thermal expansion of the glass member differs from a coefficient of thermal expansion of the metal member.

8. The assembly of claim 1, wherein the metal member includes a glass stabilizer.

9. The assembly of claim 8, wherein the glass stabilizer contains at least one of: calcium, strontium, barium, zirconium, iron, and manganese.

10. A glass-covered assembly, comprising:
an electrically conductive connection member; and
an assembly including a metal member containing a glass-forming component and a glass member bonded to the metal member in a glass-to-metal seal, the metal member is mechanically and electrically connected to the electrically conductive connection member at an interface region.

11. The glass-covered assembly of claim 10, wherein the metal member is covered by the glass member at least in the interface region.

12. An electrical device, comprising:
an electrically conductive connection member;
a temperature dependent resistive element connected to the electrically conductive connection member in an electrically conductive manner; and
an assembly including a metal member containing a glass-forming component and a glass member bonded to the metal member in a glass-to-metal seal, the metal member is mechanically and electrically connected to the electrically conductive connection member.

13. The electrical device of claim 12, wherein the glass member covers the metal member and the electrically conductive connection member.

14. A method for producing a glass-to-metal seal, comprising:
providing a metal member containing a glass-forming component; and
depositing or applying a glass melt on the metal member to form a chemical bond between the glass-forming component and a glass member formed from the glass melt.

15. The method of claim 14, further comprising providing a metal body free from the glass-forming component with the glass-forming component to form the metal member before the depositing step.

16. The method of claim 14, further comprising thermally treating the metal member to increase a rate of oxidation of the glass-forming component at least near a surface of the metal member.

17. The method of claim 14, further comprising forming a mechanical and electrical connection between the metal member and an electrically conductive connection member by welding, soldering, or wire-bonding before the depositing step.
